(19) United States
(12) Patent Application Publication
(10) Pub. No.: US 2014/0315154 A1
(43) Pub. Date: Oct. 23, 2014

(54) METHOD FOR DIMENSIONAL ADJUSTMENT FOR DENTAL SCAN, DIGITIZED MODEL OR RESTORATION

(71) Applicant: B&D Dental Corporation, West Valley City, UT (US)

(72) Inventors: Daniel Yonil Jung, Sandy, UT (US); Yunoh Jung, Sandy, UT (US)

(73) Assignee: B&D Dental Corporation, West Valley City, UT (US)

(21) Appl. No.: 14/199,551

(22) Filed: Mar. 6, 2014

Related U.S. Application Data
(60) Provisional application No. 61/774,111, filed on Mar. 7, 2013.

(51) Int. Cl. A61C 9/00; A61C 1/08; A61C 13/00

(52) U.S. Cl. CPC A61C 9/0053; A61C 13/0004; A61C 1/082
USPC 433/214

(57) ABSTRACT

A method for creating a substantially accurate dental restoration from scanning a negative dental impression of a patient's teeth or a positive dental stone model of the patient's teeth includes applying a compensation rate to compensate for the shrunk or enlarged scan of the patients teeth, to the scan of the patient's teeth using the scanner to create a true dimension working file; the scan of the patient's teeth using a computer system to create a true dimension working file; or a shrunk restoration file of the restoration using a restoration fabricator. A restoration can be designed based on the scan of the patient's teeth and creating a restoration file. The restoration can be fabricated using a restoration fabricator.

### PRIORITY CLAIM(S) AND RELATED APPLICATION(S)

Benefit is claimed of U.S. Provisional Patent Application Ser. No. 61/774,111, filed on Mar. 7, 2013; which is hereby incorporated herein by reference.

This application is related to U.S. patent application Ser. No. 14/186,515, filed Feb. 21, 2014, which claims priority to U.S. Provisional Patent Application Ser. Nos. 61/767,704 and 61/767,749, filed, Feb. 21, 2013; which are hereby incorporated herein by reference.

### BACKGROUND

1. Field of the Invention

The present invention relates generally to creating dental prosthetics based on dental impressions.

2. Related Art

The conventional procedure for producing dental prosthetics typically requires the patient to have at least two sessions with the dentist. First, an impression is taken of the dentition using an elastomeric material from which a dental gypsum cast model is made to replicate the dentition. The prosthetic is then produced from the model using metal, ceramic or a composite material. A series of steps for proper fit and comfort then follows. Thus, fabrication of custom prostheses involves intensive labor, a high degree of skill and craftsmanship, and lengthy times (1-2 days). In recent years, technological advances have provided computer automated machinery capable of fabricating prostheses using minimal human labor and drastically lower work time. This is frequently referred to as “digital dentistry,” where computer automation is combined with 3D digitizing equipment, CAD/CAM (computer-aided design/computer aided machining) equipment and mechanical milling tools.

Impression materials are used to register or reproduce the form and relations of the teeth and the surrounding oral tissues. It would be virtually impossible to perform high-quality restorative and prosthetic dentistry without impression materials. An impression is essentially a “negative” replica of some structure. In dentistry, this replica usually is made of the teeth or gingival tissues of the mandibular or maxillary arch. From the impression, it is possible to produce a replica of the dental structures by using a cast or die material, such as dental stone or some type of plastic. The replica thus is a “positive” reproduction that can be used in treatment planning or in the production of a restoration. These activities can take place in the absence of the patient; the dentist staff makes an impression of a tooth prepared for a crown while the patient sits in the dental chair, but the actual process of producing the crown takes place in a dental laboratory using a replica of the prepared tooth. This example underscores the need for accuracy and stability in dental impression materials. The final restoration fits only as accurately as the initial impression allows.

The characteristic of the impression material has a profound influence on accuracy. Because the materials transforms from a liquid paste to an elastic solid, often by polymerization, there is a dimensional change accompanying the reaction. Today, two of the most popular elastomers used in dental practice are the polyethers and addition-reaction silicones, or vinyl polysiloxanes.

Dental elastomeric impression materials are subject to several factors that can result in dimensional change. For example, the process of polymerization, which involves cross-linking of the polymer chains, can result in a reduction of spatial volume. Polymerization reactions have been shown to continue for a considerable period of time, beyond the achievement of what is considered a final clinical set, and continue after removal of the impression from the mouth. The effect of temperature as a variable has been demonstrated to alter the dimension, both during the setting phase and after the clinical set. Accuracy is dependent on material volume used, or bulk, as is the extent of undercuts encountered during the removal of the set material. The conditions under which the materials are stored and the requirement that the set impression material be disinfected are also factors demonstrated to affect the accuracy of casts.

There have been efforts to reduce the degree of shrinkage of the dental impression material. For example, see WO/2006/122074, EP0088845A2 and EP0391872 and U.S. Pat. No. 4,965,295. However, whatever methods are used, still there exists an impression shrinkage issues due to the ultimate polymer reaction process mentioned above.

Also, materials used to fabricate the replica or working cast may also be subject to changes in dimension, such as gypsum (or dental stone) expansion with setting. Dental stone linear expansion is affected by various factors like water powder mixing ratio, mixing time, mixing method, water temperature, etc.

Newer techniques have been introduced that involve using computer models of the patient's teeth taken by a scanner, and creating the restoration digitally based on the computer model. Very few dentist offices, however, have such a scanner. Thus, a dental lab can make a digital model by scanning the mold or impression of the patient's teeth received from the dentist. The scanning process can be very accurate. In addition, the digital scan can upset the balance or compensation between the shrinkage and expansion of the traditional process. A scan of an impression or mold can result in a restoration that is too small. Restorations that are too small can be unusable.

### SUMMARY OF THE INVENTION

It has been recognized that it would be advantageous to be able to generate an accurate three dimensional scan based on a dental impression or on a stone or plaster cast or model. In addition, it has been recognized that it would be advantageous to be able to make dental prosthetics or restorations based on scans of impressions or models.

The invention provides a method for creating a substantially accurate dental restoration, the method comprising: scanning 1) a negative dental impression of a patient's teeth or 2) a positive dental stone model of the patient's teeth using a three dimensional scanner to create a scan of the patient's teeth, the negative dental impression being shrunk with respect to the patient's teeth, or the positive dental stone model being shrunk or enlarged with respect to the patients teeth; applying a compensation rate, to compensate for the shrunk or enlarged scan of the patients teeth, to: 1) the scan of the patient's teeth using the scanner to create a true dimension working file, and saving the true dimension working file prior to designing and fabricating the restoration; or 2) the scan of the patient's teeth using a computer system to create a true dimension working file prior to designing and fabricating the restoration; or 3) a shrunk or enlarged restoration file of the restoration using the restoration fabricator prior to fabricating the restoration; designing a restoration based on the scan of the patient's teeth and creating a restoration file; and fabricating the restoration using a restoration fabricator.

In addition, the invention provides a method for creating a substantially accurate dental restoration, the method comprising: obtaining a negative dental impression of a patient's teeth formed of a material with a known shrinkage rate and being shrunken with respect to the patient's teeth; forming a positive dental stone model of the patient's teeth by applying a dental stone material to the negative dental impression, the dental stone material having a known expansion rate and being enlarged and having an enlarged volume with respect to the patient's teeth; determining a compensation rate based on the known shrinkage rate of the material of the negative dental impression and the known expansion rate of the material of the positive dental stone model; scanning the dental stone model of the patient's teeth using a three dimensional scanner to create an enlarged scan of the patient's teeth; applying the compensation rate to the enlarged volume of the scan of the patient's teeth to create a true dimension working file of the patient's teeth having a shrunk volume with respect to enlarged volume using the scanner; saving the true dimension working file; designing a restoration and creating a restoration file of the restoration based on the true dimension working file using the computer system; saving the restoration file; designing a cutting guide and creating a cutting guide file of the cutting guide based on the true dimension working file and the restoration file using the computer system, the cutting guide being configured to guide a cutting tool to cut a patient's tooth prior to receiving the restoration; saving the cutting guide file; retrieving the restoration file with a restoration fabricator; fabricating the restoration using the restoration fabricator; retrieving the cutting guide file with a cutting guide fabricator; and fabricating the cutting guide using the cutting guide fabricator.

Furthermore, the invention provides a method for creating a substantially accurate dental restoration and cutting guide, the method comprising: scanning 1) a negative dental impression of a patient's teeth or 2) a positive dental stone model of the patient's teeth using a three dimensional scanner to create a scan of the patient's teeth, the negative dental impression being shrunk with respect to the patient's teeth, or the positive dental stone model being shrunk or enlarged with respect to the patients teeth; applying a compensation rate, to compensate for the shrunk or enlarged scan of the patients teeth, to: 1) the scan of the patient's teeth using the scanner to create a true dimension working file, and saving the true dimension working file prior to designing and fabricating the restoration and the cutting guide; or 2) the scan of the patient's teeth using a computer system to create a true dimension working file prior to designing and fabricating the restoration and the cutting guide; or 3) a shrunk or enlarged restoration file of the restoration using a restoration fabricator prior to fabricating the restoration, and a shrunk or enlarged cutting guide file of the cutting guide using a cutting guide fabricator prior to fabricating the cutting guide; the compensation rate satisfies an equation: A³=α³B³, where A is the actual tooth size between two points, B is after-shrinkage linear distance of the same points in the impression or the model, and α is the compensation rate; designing a restoration based on the scan of the patient's teeth and creating a restoration file; fabricating the restoration using a restoration fabricator; designing a cutting guide based on the scan of the patient's teeth and the restoration, and creating a cutting guide file, the cutting guide being configured to guide a cutting tool to cut a patient's tooth prior to receiving the restoration; and fabricating the cutting guide with a cutting guide fabricator.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic view of a showing a negative dental impression of a patient's teeth and how it can be shrunken with respect to the actual true size of the patient's teeth;

FIG. 2 is a schematic block diagram of a method for creating a substantially accurate dental restoration based on a negative dental impression in accordance with embodiments of the present invention;

FIG. 3 is a graphical user interface illustrating a scan of a negative dental impression;

FIG. 4 is a schematic view of a showing a positive dental stone model of a patient's teeth and how it can be enlarged with respect to the actual true size of the patient's teeth;

FIG. 5 is a schematic view showing how a negative dental impression can be shrunken, and a positive dental stone model can be enlarged, with respect to the actual true size of the patient's teeth;

FIG. 6 is a schematic block diagram of a method for creating a substantially accurate dental restoration based on a positive dental stone model that is enlarged with respect to the actual true size of the patient's teeth in accordance with embodiments of the present invention;

FIG. 7 is a graphical user interface illustrating a scan of a positive dental stone model that is enlarged with respect to the actual true size of the patient's teeth;

FIG. 8 is a schematic view showing how a negative dental impression can be shrunken, and a positive dental stone model can be shrunken, with respect to the actual true size of the patient's teeth;

FIG. 9 is a schematic block diagram of a method for creating a substantially accurate dental restoration based on a positive dental stone model that is shrunken with respect to the actual true size of the patient's teeth in accordance with embodiments of the present invention; and

FIG. 10 is a graphical user interface illustrating a scan of a positive dental stone model at is shrunken with respect to the actual true size of the patient's teeth.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

In order to prepare a dental prosthetic or restoration, such as a crown, bridge, veneer, inlay, etc., a dentist/oral surgeon often takes an impression or mold of the patient's teeth. The dental lab can make a model of the patient's teeth using dental plaster/stone cast of the impression. The model can then be used to form the restoration, i.e. the crown, bridge, veneer, inlay, etc, to be provided to the dentist for installation on the patient's teeth.

The impression or material for taking the dental impression shrinks as the impression material sets. This shrinkage generally falls into the range of 0-2% by volume in one aspect, and often approximately 0.8% by volume in another aspect. Thus, a restoration based on the impression can be too small, and unusable. The model formed by placing dental stone into the impression expands as the model sets. This expansion can be greater than or even less than the shrinkage of the impression material. Thus, a restoration based on the model can be larger or smaller. A restoration that is too large, or even slightly smaller, often cannot be used.

As discussed above, the use of three dimensional imaging and scanning has begun to be used. In addition, computer hardware and software can be used to design and then mill the restoration. Furthermore, computer hardware and software can be used to design and then digitally print cutting guides (or prep-aid) that fit over the user's teeth and receive a cutting tool or bur to accurately and quickly cut the teeth to receive the restoration.

Having an accurate three dimensional electronic representation of a patient's teeth has several advantages. For example, with an accurate computer model of a tooth to be drilled, a preparation-aid device, i.e. a cutting guide, can be designed using computer software to determine an accurate cutting path to prepare the tooth to receive the restoration. The guide can be installed over the patient's teeth to guide the cutting tool. One or more slots in the cutting guide can receive the cutting tool, or guide pins on the handpiece, to guide the cutting tool to cut the tooth as modeled by the computer and to receive the restoration. Knowing the shape of the drilled area beforehand allows a dental prosthetic matching the area to be generated prior to the actual arrival of the patient. This pre-fabrication allows for the cutting of the tooth and fitting of the dental prosthetic in a single visit, rather than having the patient come in, have a tooth drilled, take an impression, and make a working model, forming the prosthetic, and having the patient return and fit the prosthetic in a separate later visit. This method is undesirable as the patient may be in a significant amount of pain during the interval between drilling and fitting of the prosthetic.

Being able to have a dental prosthetic based on an accurate teeth model ready before the patient ever arrives for drilling and able to perform all invasive functions in a single visit would greatly increase a patient's quality of treatment and care.

The invention involves the use of a three dimensional scanning technology. Although few dentists have scanning equipment, a dental lab can scan the impression and/or a mold created therefrom. While the expansion of dental stone can compensate or over compensate for the shrinkage of dental impression material, the scan of the impression or model can be very accurate, and can simply reproduce any shrinkage or enlargement.

Whether the impression material or gypsum model is scanned, the 3D dimensional teeth size represented by these intermediaries is not the same size as the real teeth of the patient. The shrinkage rate of the impression material and the expansion rate of the gypsum material can be identified in order to create a real dimension from the scanned image. A compensating process can be applied between the shrunk impression dimension and expanded stone model dimension. In this way, an accurate restoration can be made from a 3D scanned image of a dental stone model prepared based off of impression material. There has not been any effort or known teaching regarding the method or technique of applying a compensation multiplier to bridge the gap between the inaccuracy of the scanned image and the real teeth. With the conventional restoration making method, these compensation processes were not as needed. But in the CAD/CAM method, especially in a process where the restoration is pre-made followed by a digital preparation by computer software, all the manufacturing parameters may need to be within tight tolerances. Processes like this require a 3D dimensional size modified by the compensating multiplier to get an accurate restoration. Also, the preparation guide or cutting guide used by the dentist to do the guided cutting made from this adjusting method can fit accurately without being too tight or being too loose.

The method of the present invention involves using three dimensional scanners to scan the dental impressions or scan the stone/plaster working models formed from the dental impressions. However, as discussed above, error due to shrinkage or expansion of the impressions and stone plaster would propagate some error into the scanned models. Further, if the final dental prosthetic is too small, it is unusable, because it will not fit and further grinding of the tooth to achieve a fit may not be possible. Alternatively, if the dental prosthetic is unreasonably large it becomes unusable as grinding may not provide a sufficient fit. Having a process to reliably correct this error in the production of a preparation aid device or a restoration/dental prosthetic would be highly desirable.

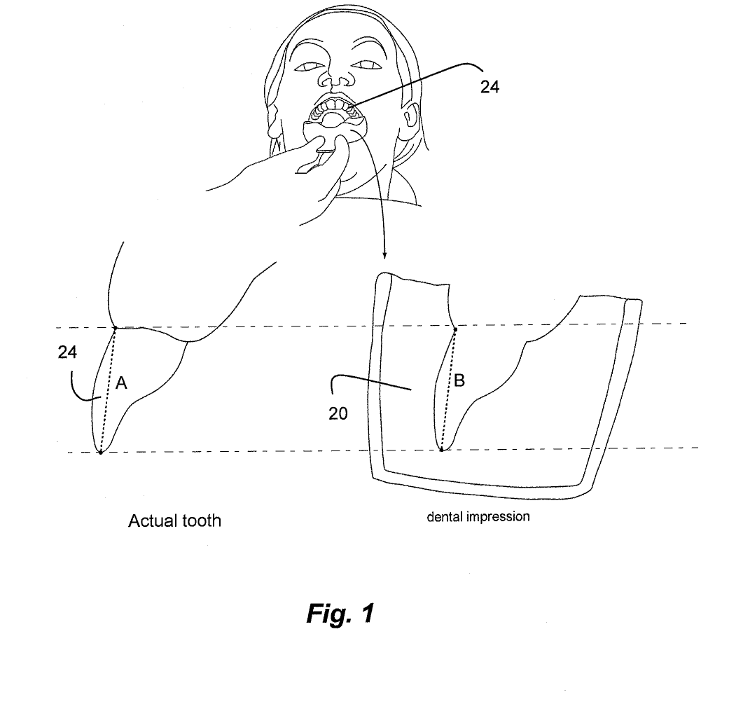

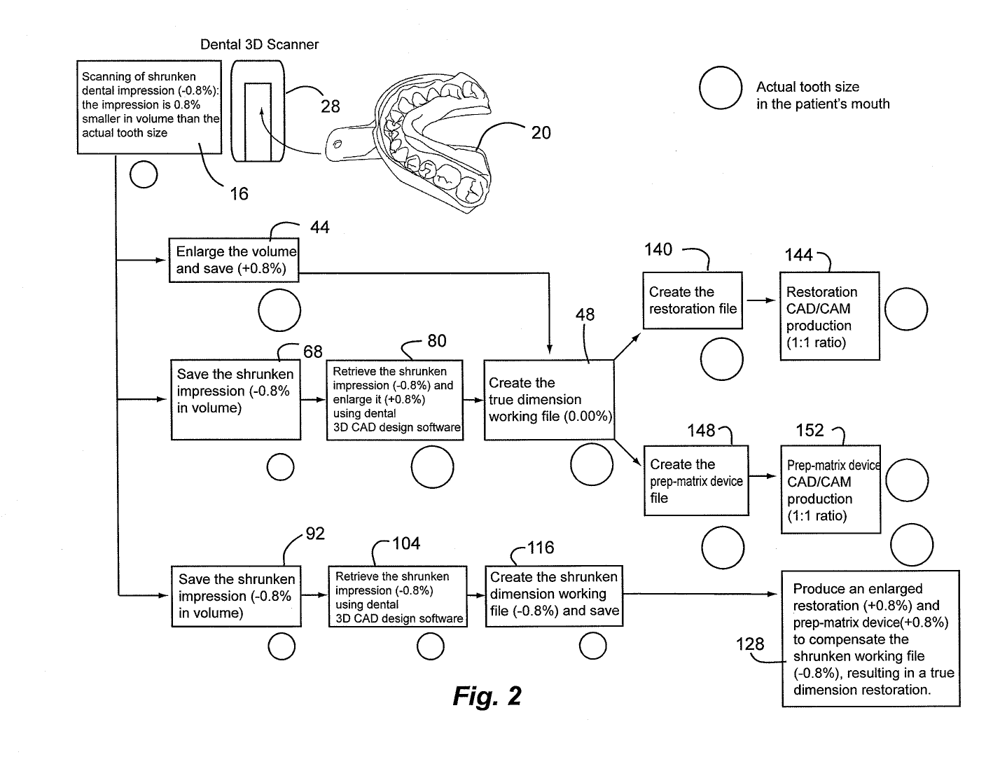

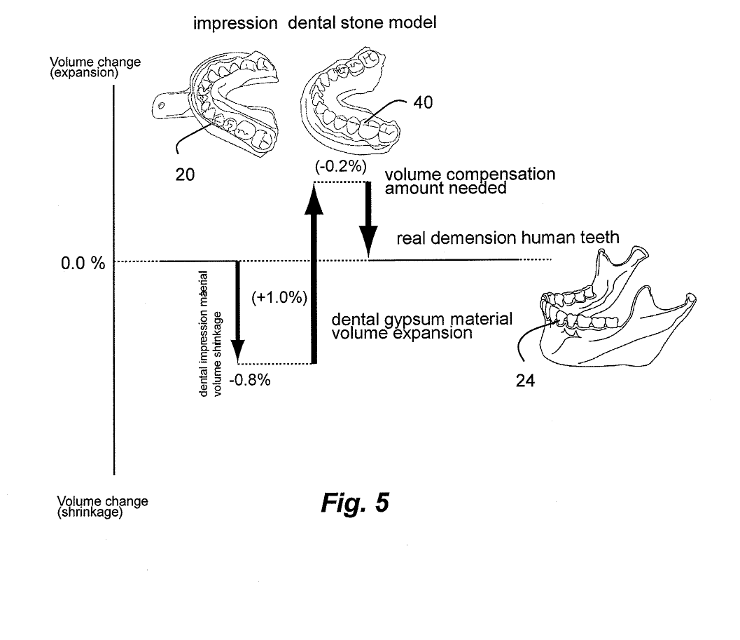

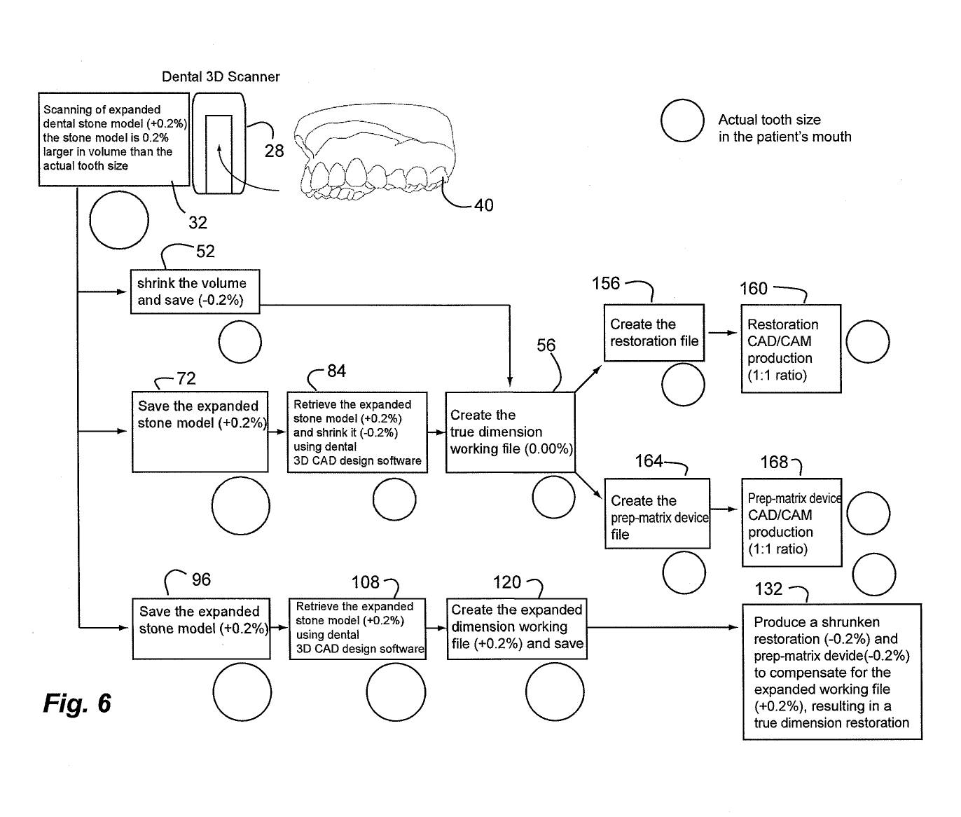

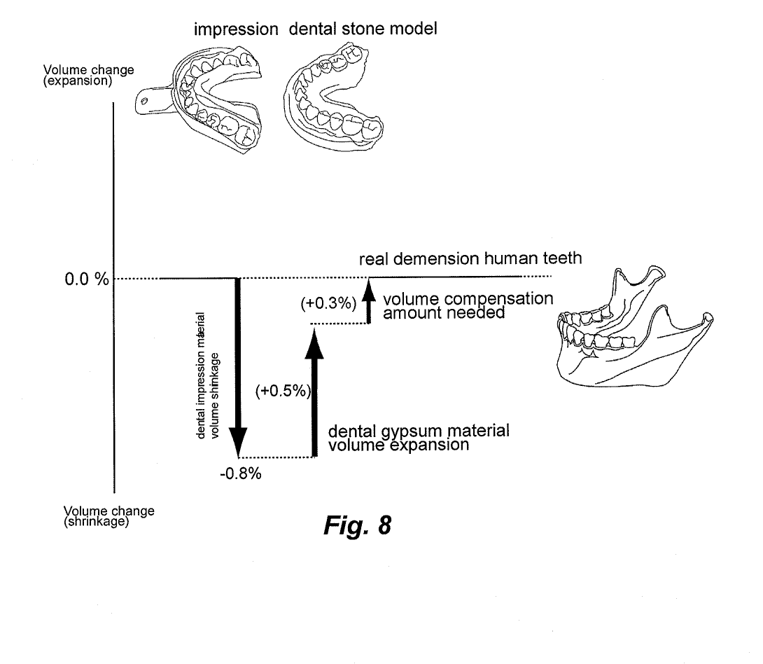

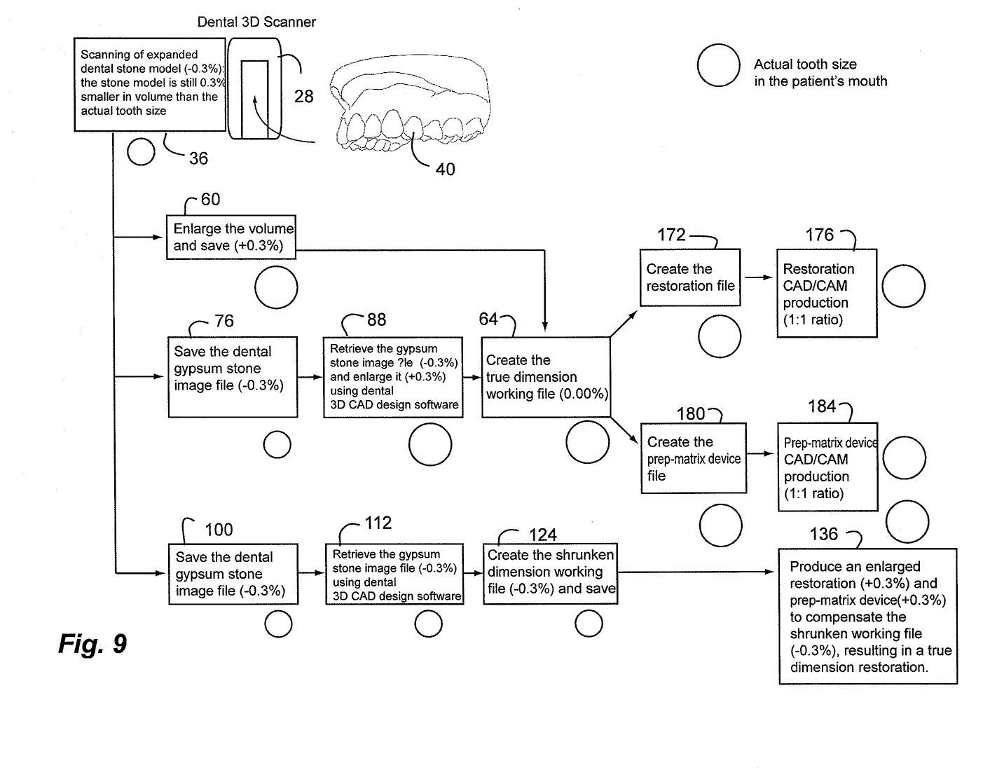

Referring to FIGS. 1-10, methods for creating a substantially accurate dental restoration, such as crowns, bridges, veneers, inlays, etc., are shown. In one aspect, the method includes scanning 16 a negative dental impression 20 of a patient's teeth 24 with a three-dimensional scanner 28, as shown in FIG. 2. The scanner can use light or laser light to scan the impression 20. The impression can be obtained from a dentist who has the patient bite into an impression material. As described above, the impression, and thus the scan thereof, can be between 0-2% shrunken by volume with respect to the patient's actual teeth due to shrinkage of the impression or material thereof as it cures. The shrinkage can average closer to 0.8% by volume. The shrinkage rate of the can be known or a known value. In some instances, it can be difficult to obtain an accurate scan of the impression due to the difficulty of getting a laser light into some of the cavities of the impression. Thus, a positive dental 32 stone model of the patient's teeth 24 can be made using the negative dental impression, such as by applying a dental stone material, into the impression and allowing it to cure. In another aspect, the method includes scanning 32 or 36 (FIGS. 6 and 9, respectively) a positive dental stone model 40 of the patient's teeth 24 using a three dimensional scanner 28 to create a scan of the patient's teeth, as shown in FIGS. 6 and 9. The dental stone material can enlarge as it cures to be larger than the patient's teeth, as shown in FIG. 5, or still smaller than the user's teeth, as shown in FIG. 8. As, discussed above the dental stone material can generally expand beyond the shrinkage of the dental impression, such as with 1% by volume, resulting in a dental stone model that is 0.2% larger than the patient's actual teeth, as shown in FIG. 5. Thus, the positive dental stone model can be enlarged with respect to the patient's actual teeth. Sometimes, however, the dental stone material can expand less than the shrinkage of the dental impression, such as with 0.5% by volume, resulting in a dental stone model that is still 0.3% smaller than the patient's actual teeth, as shown in FIG. 8. Thus, the positive dental stone model can still be shrunken with respect to the patient's actual teeth. The scan of the patient's teeth can generate a scan or model of the patient's teeth, that can be saved as a file in the scanner or a computer system operatively coupled thereto.

From the scan of the patient's teeth, a restoration, such as a crown, bridge, veneer, inlay, etc., can be designed and modeled using a computer system with executable instructions, such as 3D design software/system, based on the scan of the patient's teeth or file thereof. The computer system can be operatively coupled to the scanner or computer system thereof. Similarly, a cutting guide or prep aid or prep matrix can be designed and modeled using the computer system with executable instructions, such as the 3d design software, based on the scan of the patient's teeth and the restoration, or model thereof. A restoration file and a cutting guide file can be created and saved with the computer system. The cutting guide can fit on the user's teeth, either the tooth to be cut, or adjacent and remote teeth, and can have slots to guide and a cutting tool and/or dental handpiece to cut a patient's tooth prior to receiving the restoration. The cutting path of the cutting tool can also be designed and modeled on the computer system based on the scan of the patient's teeth, and the restoration. The restoration can be fabricated using a restoration fabricator using the restoration file. For example the restoration can fabricated by milling the restoration from stock material using a milling machine with a cutting tool. The cutting guide can be fabricated using a cutting guide fabricator using the cutting guide file. For example, the cutting guide can be fabricated by printing the cutting guide with a 3D printer.

The method comprises applying a compensation rate to compensate for the shrunk or enlarged scan of the patients teeth. The method can also comprise determining the compensation rate. In one aspect, the compensation rate can be determined based on a known shrinkage rate of a material of the negative dental impression, if the restoration and cutting guide are based on only the scan of the negative dental impression. In another aspect, the compensation rate can be determined based on the known shrinkage rate of the material of the negative dental impression, and a known expansion rate of a material of the positive dental stone model, if the restoration and the cutting guide are based on the scan of the positive dental stone model. Thus, the compensation rate can be based on a shrinkage of the negative dental impression, or the shrinkage of the negative dental impression and the expansion of the positive dental stone model. The compensation rate can be a multiplier (enlarging or reducing or shrinking) applied to the volume of the dental scan, or the restoration and the cutting guide. In addition, the compensation rate can be applied by the scanner at a scanning stage, the computer system at the designing state, or the fabricators (restoration or cutting guide) at a fabrication stage.

In one aspect, the compensation rate can be applied to the scan of the patient's teeth using the scanner to create a true dimension working file. Applying the compensation rate can enlarge the volume 44 (such as by 0.8%), and create a true dimension working file that can be saved 48 prior to designing and fabricating the restoration or cutting guide, as shown in FIG. 2. Applying the compensation rate can shrink the volume 52 (such as by −0.2%), and create a true dimension working file that can be saved 56 prior to designing and fabricating the restoration or cutting guide, as shown in FIG. 6. Applying the compensation rate can enlarge the volume 60 (such as by 0.3%), and create a true dimension working file that can be saved 64 prior to designing and fabricating the restoration or cutting guide, as shown in FIG. 9.

In another aspect, the compensation rate can be applied to the scan of the patient's teeth using the computer system to create a true dimension working file prior to designing and fabricating the restoration. For example, the scan can be a shrunk or enlarged scan with a shrunk or enlarged volume with respect to the patient's teeth, that is saved as a shrunk or enlarged file 68, 72 and 76 (in FIGS. 2, 6 and 9, respectively) by the scanner or computer system operatively coupled thereto. The computer system or 3D design software/system can retrieve 80, 84 and 88 (in FIGS. 2, 6 and 9, respectively) the shrunk or enlarged file and apply the compensation rate to obtain the true dimension working file 48, 56, 64 (in FIGS. 2, 6 and 9, respectively).

In another aspect, the compensation rate can be applied to a shrunk restoration file of the restoration using the restoration fabricator prior to fabricating the restoration. Similarly, the compensation rate can be applied to the cutting guide using the cutting guide fabricator prior to fabricating the cutting guide. For example, the scan can be a shrunk or enlarged scan with a shrunk or enlarged volume with respect to the patient's teeth, that is saved as a shrunk or enlarged file 92, 96 and 100 (in FIGS. 2, 6 and 9, respectively) by the scanner or computer system operatively coupled thereto. The computer system or 3D design software/system can retrieve 104, 108 and 112 (in FIGS. 2, 6 and 9, respectively) the shrunk or enlarged file and apply and create a shrunken or enlarged dimension working file 116, 120 and 124, and an associated shrunken or enlarged restoration file, and an associated shrunken or enlarged cutting guide file. The shrunken or enlarged restoration and cutting guide files can be retrieved by the fabricators or a computer system operatively coupled thereto. Applying the compensation rate can enlarge or shrink the shrunken or enlarged restoration and cutting guide files 128, 132 and 136 (in FIGS. 2, 6 and 9, respectively).

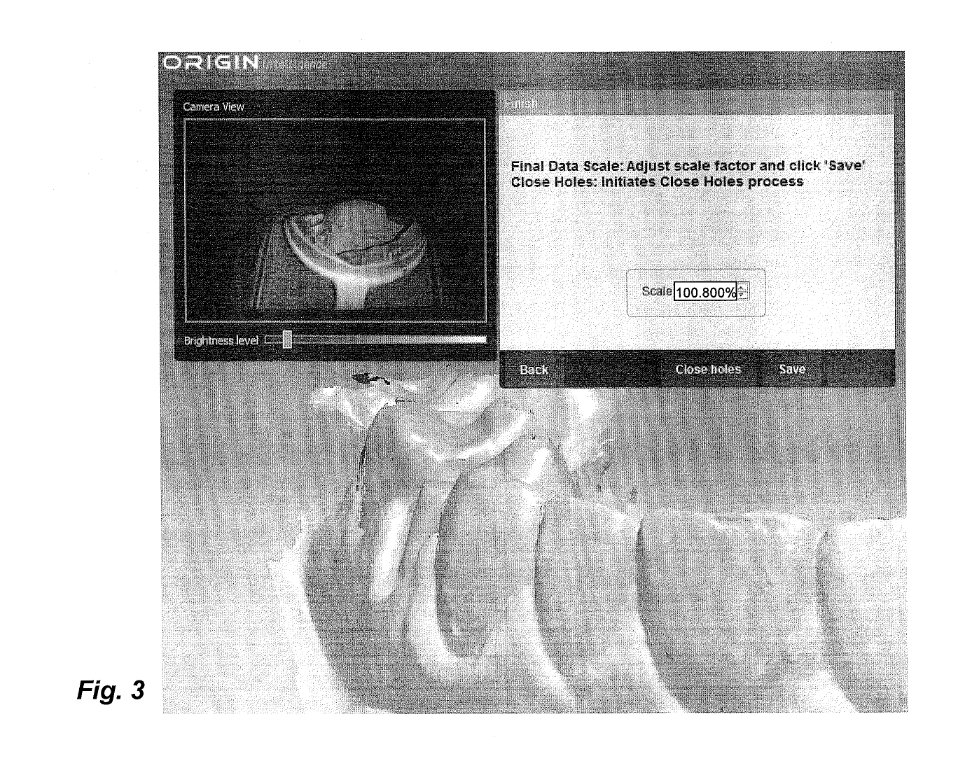

Referring to FIG. 2, the negative dental impression 20 of the patient's teeth 24 can be scanned 16 by the scanner 28 creating a shrunk scan of the patient's teeth with a shrunk volume. In one aspect, the compensation rate can be applied 44 to the shrunk volume of the scan of the patient's teeth to create a true dimension working file 46 of the patient's teeth having an enlarged volume with respect to the shrunk volume. The compensation rate can be approximately 0.8% (positive or increase or enlarging), based on a volume shrinkage of −0.8% of the impression material. The compensation rate can be applied using the scanner, as shown in FIG. 3. A user can input the compensation rate into the scanner or the computer system coupled thereto, as shown in FIG. 3. In addition, the true dimension working file 46 can be saved by the scanner. The compensation rate can be applied, and the true dimension working file saved, prior to designing and fabricating the restoration, and cutting guide. The method can include retrieving the true dimension working file with the computer system; creating a restoration file 140 of the restoration based on the true dimension working file using the computer system; and saving the restoration file. The restoration file can be retrieved by the restoration fabricator, and the restoration fabricated 144. Similarly, the method can include creating a cutting guide file 148 of the cutting guide based on the true dimension working file and the restoration file using the computer system; and saving the cutting guide file. The cutting guide file can be retrieved by the cutting guide fabricator, and the cutting guide fabricated 152.

Still referring to FIG. 2, in another aspect, a file of the shrunk scan can be saved 68 by the scanner or computer coupled thereto. The file of the shrunk scan can be retrieved 80 using the computer system. The compensation rate can be applied 80 to the shrunk volume of the shrunk scan of the patient's teeth to create true dimension working file of the patient's teeth having an enlarged volume with respect to the shrunk volume using the computer system. As described above, the method can include creating a restoration file 140 of the restoration based on the true dimension working file using the computer system; and saving the restoration file. The restoration file can be retrieved by the restoration fabricator, and the restoration fabricated 144. Similarly, the method can include creating a cutting guide file 148 of the cutting guide based on the true dimension working file and the restoration file using the computer system; and saving the cutting guide file. The cutting guide file can be retrieved by the cutting guide fabricator, and the cutting guide fabricated 152.

Still referring to FIG. 2, in another aspect, a file of the shrunk scan can be saved 92 by the scanner or computer coupled thereto. The file of the shrunk scan can be retrieved 104 using the computer system, defining a shrunk dimension working file. A shrunk restoration file of the restoration can be created based on the shrunk dimension working file using the computer system; and the shrunk restoration file can be saved. Similarly, a shrunk cutting guide file of the cutting guide can be created based on the shrunk dimension working file and the shrunk restoration file using the computer system; and the shrunk cutting guide file can be saved. A true dimension restoration can be produced 128 using the restoration fabricator by applying the compensation rate to a volume of the shrunk restoration file. Similarly, a true dimension cutting guide can be produced 128 using the cutting guide fabricator by applying the compensation rate to a volume of the shrunk cutting guide file.

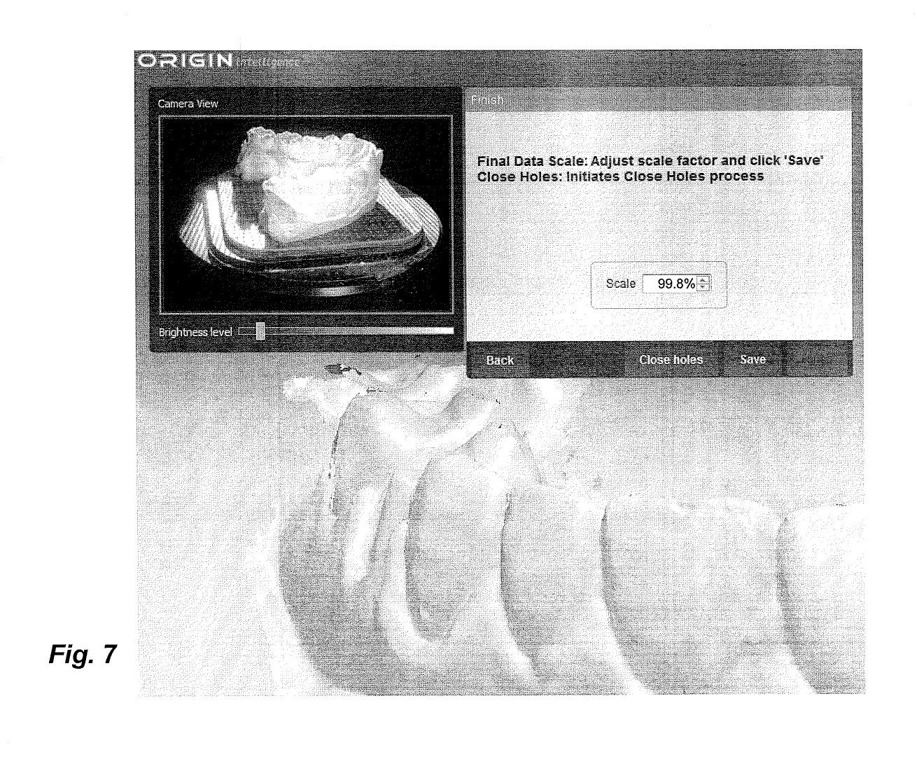

Referring now to FIG. 6, the positive dental stone model 40 of the patient's teeth 24 can be scanned 32 by the scanner 28 creating an enlarged scan of the patient's teeth with an enlarged volume. In one aspect, the compensation rate can be applied 52 to the enlarged volume of the scan of the patient's teeth to create a true dimension working file 56 of the patient's teeth having a shrunk volume with respect to enlarged volume using the scanner. The compensation rate can be approximately −0.2% (negative or decrease or shrinking), and can be based on a volume shrinkage of −0.8% of the impression material, and a 1.0% expansion of the dental stone model material, as shown in FIG. 5. Again, the compensation rate can be applied using the scanner, as shown in FIG. 7. A user can input the compensation rate into the scanner or the computer system coupled thereto, as shown in FIG. 7. In addition, the true dimension working file 56 can be saved by the scanner. The compensation rate can be applied, and the true dimension working file saved, prior to designing and fabricating the restoration, and cutting guide. The method can include retrieving the true dimension working file with the computer system; creating a restoration file 156 of the restoration based on the true dimension working file using the computer system; and saving the restoration file. The restoration file can be retrieved by the restoration fabricator, and the restoration fabricated 160. Similarly, the method can include creating a cutting guide file 164 of the cutting guide based on the true dimension working file and the restoration file using the computer system; and saving the cutting guide file. The cutting guide file can be retrieved by the cutting guide fabricator, and the cutting guide fabricated 168. The restoration can be fabricated from the restoration file at a 1:1 ratio using the restoration fabricator. Similarly, the cutting guide can fabricated from the fabrication file at a 1:1 ratio using the cutting guide fabricator.

Still referring to FIG. 6, in another aspect, a file of the enlarged scan can be saved 72 by the scanner or computer coupled thereto. The file of the enlarged scan can be retrieved 84 using the computer system. The compensation rate can be applied 84 to the enlarged volume of the enlarged scan of the patient's teeth to create true dimension working file of the patient's teeth having an shrunk volume with respect to the enlarged volume using the computer system. As described above, the method can include creating a restoration file 156 of the restoration based on the true dimension working file using the computer system; and saving the restoration file. The restoration file can be retrieved by the restoration fabricator, and the restoration fabricated 160. Similarly, the method can include creating a cutting guide file 164 of the cutting guide based on the true dimension working file and the restoration file using the computer system; and saving the cutting guide file. The cutting guide file can be retrieved by the cutting guide fabricator, and the cutting guide fabricated 168.

Still referring to FIG. 6, in another aspect, a file of the enlarged scan can be saved 96 by the scanner or computer coupled thereto. The file of the enlarged scan can be retrieved 108 using the computer system, defining an enlarged dimension working file. An enlarged restoration file of the restoration can be created based on the enlarged dimension working file using the computer system; and the enlarged restoration file can be saved. Similarly, an enlarged cutting guide file of the cutting guide can be created based on the enlarged dimension working file and the enlarged restoration file using the computer system; and the enlarged cutting guide file can be saved. A true dimension restoration can be produced 132 using the restoration fabricator by applying the compensation rate to a volume of the enlarged restoration file. Similarly, a true dimension cutting guide can be produced 132 using the cutting guide fabricator by applying the compensation rate to a volume of the enlarged cutting guide file.

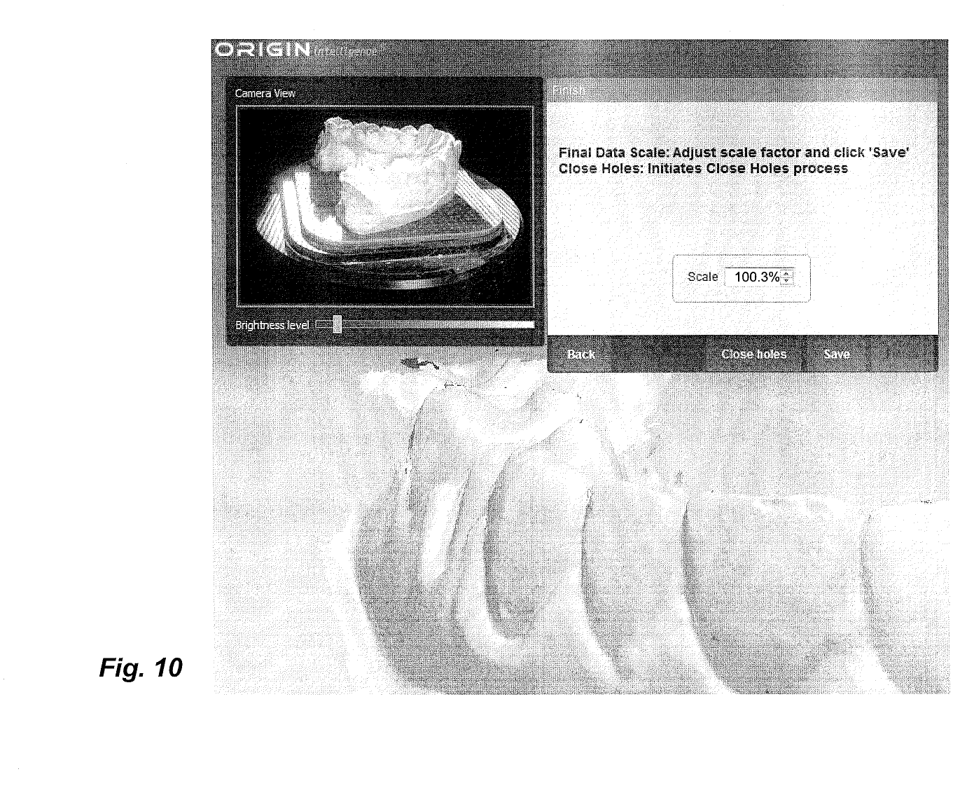

Referring now to FIG. 9, the positive dental stone model 40 of the patient's teeth 24 can be scanned creating a shrunk scan of the patient's teeth with a shrunk volume. In one aspect, the compensation rate can be applied 60 to the shrunk volume of the scan of the patient's teeth to create a true dimension working file 64 of the patient's teeth having an enlarged volume with respect to the shrunk volume using the scanner. The compensation rate can be approximately 0.3% (positive or increase or enlarging), and can be based on a volume shrinkage of −0.8% of the impression material, and a 0.5% expansion of the dental stone model material, as shown in FIG. 8. Again, the compensation rate can be applied using the scanner, as shown in FIG. 10. A user can input the compensation rate into the scanner or the computer system coupled thereto, as shown in FIG. 10. In addition, the true dimension working file 64 can be saved by the scanner. The compensation rate can be applied, and the true dimension working file saved, prior to designing and fabricating the restoration, and cutting guide. The method can include retrieving the true dimension working file with the computer system; creating a restoration file 172 of the restoration based on the true dimension working file using the computer system; and saving the restoration file. The restoration file can be retrieved by the restoration fabricator, and the restoration fabricated 176. Similarly, the method can include creating a cutting guide file 180 of the cutting guide based on the true dimension working file and the restoration file using the computer system; and saving the cutting guide file. The cutting guide file can be retrieved by the cutting guide fabricator, and the cutting guide fabricated 184.

Still referring to FIG. 9, in another aspect, a file of the shrunk scan can be saved 76 by the scanner or computer coupled thereto. The file of the shrunk scan can be retrieved 88 using the computer system. The compensation rate can be applied 88 to the shrunk volume of the shrunk scan of the patient's teeth to create true dimension working file of the patient's teeth having an enlarged volume with respect to the shrunk volume using the computer system. As described above, the method can include creating a restoration file 172 of the restoration based on the true dimension working file using the computer system; and saving the restoration file. The restoration file can be retrieved by the restoration fabricator, and the restoration fabricated 176. Similarly, the method can include creating a cutting guide file 180 of the cutting guide based on the true dimension working file and the restoration file using the computer system; and saving the cutting guide file. The cutting guide file can be retrieved by the cutting guide fabricator, and the cutting guide fabricated 184.

Still referring to FIG. 9, in another aspect, a file of the shrunk scan can be saved 100 by the scanner or computer coupled thereto. The file of the shrunk scan can be retrieved 112 using the computer system, defining a shrunk dimension working file. A shrunk restoration file of the restoration can be created based on the shrunk dimension working file using the computer system; and the shrunk restoration file can be saved. Similarly, a shrunk cutting guide file of the cutting guide can be created based on the shrunk dimension working file and the shrunk restoration file using the computer system; and the shrunk cutting guide file can be saved. A true dimension restoration can be produced 136 using the restoration fabricator by applying the compensation rate to a volume of the shrunk restoration file. Similarly, a true dimension cutting guide can be produced 136 using the cutting guide fabricator by applying the compensation rate to a volume of the shrunk cutting guide file.

### Example

An example with an actual clinical case used impression material, gypsum material, a 3D dental scanner, restoration making CAD software and proprietary software to manufacture the cutting guide by 3D printing technique.

The same impression material was used to take the impression of the patient on the full arch impression tray. Then, the 3D dental white-light scanner was used to scan the full arch impression. This scanned image was retrieved on the computer monitor to 3D print a preparation guide for dentist to use. To design the right preparation guide, the full arch scanned teeth image on the monitor was enlarged by applying the compensation rate (or enlarging multiplier). The enlargement multipliers, or scale factor, of 100.10%, 100.20%, 100.30%, 100.40%, 100.50%, 100.60%, 100.70%, 100.80%, 100.90%, 101.00% or 1.001, 1.002, 1.003, 1.004, 1.005, 1.006, 1.007, 1.008, 1.009, 1.010 were respectively applied to the original scanned image of the impression mold. A total of 10 preparation guides were designed using software and were manufactured by 3D printing method. These ten preparation guides were tested for accurate fit in the patient's mouth. Table 1 shows the results. As show in Table 1, none of the preparation guide samples fit in on the patient's teeth except sample number 8, which was produced by enlarging the original scanned image by 0.8%. This is, technically, the same as applying the enlarging multiplier, or scale factor, of 100.8%, or alternatively expressed as 1.008.

TABLE 1
Impression scanning and enlarging multiplier

| | Enlarge the | | | |
|---|---|---|---|---|
| | scanned | Enlarging multiplier | | |
| | volume by | or scale factor | | Fit in the mouth |
| Sample 1 | 0.10% | 100.10% | 1.001 | does not fit (too tight) |
| Sample 2 | 0.20% | 100.20% | 1.002 | does not fit (too tight) |
| Sample 3 | 0.30% | 100.30% | 1.003 | does not fit (too tight) |
| Sample 4 | 0.40% | 100.40% | 1.004 | does not fit (too tight) |
| Sample 5 | 0.50% | 100.50% | 1.005 | does not fit (too tight) |
| Sample 6 | 0.60% | 100.60% | 1.006 | does not fit (too tight) |
| Sample 7 | 0.70% | 100.70% | 1.007 | does not fit (tight) |
| Sample 8 | 0.80% | 100.80% | 1.008 | perfect fit |
| Sample 9 | 0.90% | 100.90% | 1.009 | does not fit (loose) |
| Sample 10 | 1.00% | 101.00% | 1.010 | does not fit (too loose) |

Dental impression materials can shrink (with a linear shrinkage rate of 0.01-2.0%) during the setting period. The inter-occlusal recording materials present significantly different polymerization shrinkage-strain kinetics and show dimensional changes even after the setting time indicated by respective manufacturers.

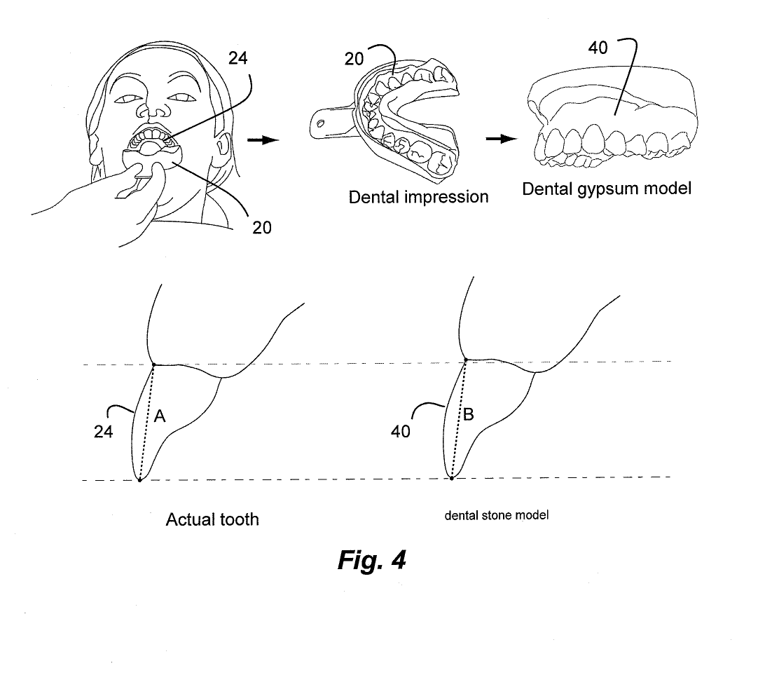

With impression scanning, the 3D volume of the scanned teeth image in the impression material can be multiplied by the expansion compensation rate α³ that satisfies an equation A³=α³B³, where A is the actual tooth size between two points and B is after-shrinkage or after-enlargement linear distance of the same points or corresponding points in the impression or impression image (FIG. 1), or model or model image (FIG. 4). For example, if linear distance A=10.00 mm and linear distance B is 9.973 mm, α³ would be 1.008. In this case, the compensation rate or the enlarging multiplier α³ would be 100.8% or 1.008.

With stone scanning, A is the actual tooth size between two points and B would be a distance between the same two points on the stone model. If A is 10.00 mm and B is 10.0055 mm, then α³ would be 0.998. In this case, the compensation rate or the reducing multiplier α³ would be 99.8% or 0.998. This means that in order to make an accurate preparation guide, the scanned stone image should be saved as 99.8% the volume size of the original scanned image, or the actual stone volume should be shrunk by 0.2% to make a true dimension working file. The test result are shown in Table 2. None of these ten samples fit correct on the patient's teeth except for sample number 15.

If the stone model has not expanded enough to match the actual tooth size, then enlarging the scanned image is needed by applying the enlarging multiplier through the similar process as introduced in table 1.

TABLE 2
Stone model scanning and reducing multiplier

| | Shrink the | | | |
|---|---|---|---|---|
| | scanned | Reducing multiplier | | |
| | volume by | or scale factor | | Fit in the mouth |
| Sample 11 | 0.01% | 99.99% | 0.9999 | does not fit (too loose) |
| Sample 12 | 0.05% | 99.95% | 0.9995 | does not fit (too loose) |
| Sample 13 | 0.10% | 99.90% | 0.9990 | does not fit (too loose) |
| Sample 14 | 0.15% | 99.85% | 0.9985 | does not fit (loose) |
| Sample 15 | 0.20% | 99.80% | 0.9980 | perfect fit |
| Sample 16 | 0.25% | 99.75% | 0.9975 | does not fit (tight) |
| Sample 17 | 0.30% | 99.70% | 0.9970 | does not fit (too tight) |
| Sample 18 | 0.35% | 99.65% | 0.9965 | does not fit (too tight) |
| Sample 19 | 0.40% | 99.60% | 0.9960 | does not fit (too tight) |
| Sample 20 | 0.45% | 99.55% | 0.9955 | does not fit (too tight) |

To summarize the findings, the needed adjustments and relationship between the actual tooth size and the scanned image of either the impression material or stone model is presented in Table 3.

TABLE 3
Actual tooth size and needed adjustment of scanned images

| | distance (mm) | | | | compensation rate | | needed adjustment | | |
|---|---|---|---|---|---|---|---|---|---|
| | A | B | | | (or multiplier or | | Enlarge the | Shrink the | |
| scanned | (actual | (scanned | | | scale factor) | | scanned | scanned | |
| image | tooth) | image) | A³ | B³ | a³ | a³ | volume by | volume by | Notes |
| impression | 10 | 9.973 | 1000 | 991.922 | 1.008144 | 100.8% | 0.81% | | Method |
| scanning | | | | | | | | | 1-3 |
| stone | 10 | 10.0055 | 1000 | 1001.651 | 0.998352 | 99.8% | | 0.20% | Method |
| model | | | | | | | | | 4-6 |
| scanning 1 | | | | | | | | | |
| stone | 10 | 9.990 | 1000 | 997.003 | 1.003006 | 100.3% | 0.30% | | Method |
| model | | | | | | | | | 7-9 |
| scanning 2 | | | | | | | | | |

The method can comprise completing any of the method under the control of one or more computer systems configured with executable instructions.

A computing device may include one or more processors that are in communication with memory devices. The computing device may include a local communication interface for the components in the computing device. For example, the local communication interface may be a local data bus and/or any related address or control busses as may be desired.

The memory device may contain modules that are executable by the processor(s) and data for the modules. Located in the memory device are modules executable by the processor. The modules may execute the functions described earlier. A data store may also be located in the memory device for storing data related to the modules and other applications along with an operating system that is executable by the processor(s).

Other applications may also be stored in the memory device and may be executable by the processor(s). Components or modules discussed in this description that may be implemented in the form of software using high programming level languages that are compiled, interpreted or executed using a hybrid of the methods.

The computing device may also have access to I/O (input/output) devices that are usable by the computing devices. An example of an I/O device is a display screen that is available to display output from the computing devices. Other known I/O device may be used with the computing device as desired. Networking devices and similar communication devices may be included in the computing device. The networking devices may be wired or wireless networking devices that connect to the internet, a LAN, WAN, or other computing network.

The components or modules that are shown as being stored in the memory device may be executed by the processor. The term “executable” may mean a program file that is in a form that may be executed by a processor. For example, a program in a higher level language may be compiled into machine code in a format that may be loaded into a random access portion of the memory device and executed by the processor, or source code may be loaded by another executable program and interpreted to generate instructions in a random access portion of the memory to be executed by a processor. The executable program may be stored in any portion or component of the memory device. For example, the memory device may be random access memory (RAM), read only memory (ROM), flash memory, a solid state drive, memory card, a hard drive, optical disk, floppy disk, magnetic tape, or any other memory components.

The processor may represent multiple processors and the memory may represent multiple memory units that operate in parallel to the processing circuits. This may provide parallel processing channels for the processes and data in the system. The local interface may be used as a network to facilitate communication between any of the multiple processors and multiple memories. The local interface may use additional systems designed for coordinating communication such as load balancing, bulk data transfer, and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media.

Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for creating a substantially accurate dental restoration, the method comprising:
a) scanning a negative dental impression of a patient's teeth or a positive dental stone model of the patient's teeth using a three dimensional scanner to create a scan of the patient's teeth, the negative dental impression being shrunk with respect to the patient's teeth, or the positive dental stone model being shrunk or enlarged with respect to the patients teeth;
b) applying a compensation rate, to compensate for the shrunk or enlarged scan of the patients teeth, to:
i) the scan of the patient's teeth using the scanner to create a true dimension working file, and saving the true dimension working file prior to designing and fabricating the restoration; or
ii) the scan of the patient's teeth using a computer system to create a true dimension working file prior to designing and fabricating the restoration; or
iii) a shrunk or enlarged restoration file of the restoration using the restoration fabricator prior to fabricating the restoration;
c) designing a restoration based on the scan of the patient's teeth and creating a restoration file; and
d) fabricating the restoration using a restoration fabricator.

2. The method in accordance with claim 1, further comprising completing any of the method under the control of one or more computer systems configured with executable instructions.

3. The method in accordance with claim 1, further comprising:
a) designing a cutting guide based on the scan of the patient's teeth and the restoration, and creating a cutting guide file, the cutting guide being configured to guide a cutting tool to cut a patient's tooth prior to receiving the restoration; and
b) fabricating the cutting guide with a cutting guide fabricator.

4. The method in accordance with claim 3, further comprising:
applying a compensation rate to the cutting guide with the cutting guide fabricator prior to fabricating the cutting guide.

5. The method in accordance with claim 1, further comprising:
determining the compensation rate based on a known shrinkage rate of a material of the negative dental impression, or the known shrinkage rate of the material of the negative dental impression and a known expansion rate of a material of the positive dental stone model.

6. The method in accordance with claim 1, wherein the compensation rate is based on a shrinkage of the negative dental impression, or the shrinkage of the negative dental impression and the expansion of the positive dental stone model.

7. The method in accordance with claim 1, wherein the compensation rate is applied to a volume of the scan of the patient's teeth, a volume of the restoration, or a volume of the cutting guide.

8. The method in accordance with claim 3, wherein the negative dental impression of the patient's teeth is scanned creating a shrunk scan of the patient's teeth with a shrunk volume; and further comprising:
applying the compensation rate to the shrunk volume of the scan of the patient's teeth to create a true dimension working file of the patient's teeth having an enlarged volume with respect to the shrunk volume using the scanner;
saving the true dimension working file;
retrieving the true dimension working file with the computer system;
creating a restoration file of the restoration based on the true dimension working file using the computer system;
saving the restoration file;
creating a cutting guide file of the cutting guide based on the true dimension working file and the restoration file using the computer system; and
saving the cutting guide file.

9. The method in accordance with claim 3, wherein the negative dental impression of the patient's teeth is scanned creating a shrunk scan of the patient's teeth with a shrunk volume; and further comprising:
saving a file of the shrunk scan;
retrieving the file of the shrunk scan using the computer system;
applying the compensation rate to the shrunk volume of the shrunk scan of the patient's teeth to create true dimension working file of the patient's teeth having an enlarged volume with respect to the shrunk volume using the computer system;
creating a restoration file of the restoration based on the true dimension working file using the computer system;
saving the restoration file;
creating a cutting guide file of the cutting guide based on the true dimension working file and the restoration file using the computer system; and
saving the cutting guide file.

10. The method in accordance with claim 3, wherein the negative dental impression of the patient's teeth is scanned creating a shrunk scan of the patient's teeth with a shrunk volume; and further comprising:
saving a file of the shrunk scan;
retrieving the file of the shrunk scan with the computer system defining a shrunk dimension working file;
creating a shrunk restoration file of the restoration based on the shrunk dimension working file using the computer system;
saving the shrunk restoration file;
creating a shrunk cutting guide file of the cutting guide based on the shrunk dimension working file and the shrunk restoration file using the computer system;
saving the shrunk cutting guide file;
producing a true dimension restoration using the restoration fabricator by applying the compensation rate to a volume of the shrunk restoration file; and
producing a true dimension cutting guide using the cutting guide fabricator by applying the compensation rate to a volume of the shrunk cutting guide file.

11. The method in accordance with claim 3, wherein the positive dental stone model of the patient's teeth is scanned creating an enlarged scan of the patient's teeth with an enlarged volume; and further comprising:
applying the compensation rate to the enlarged volume of the scan of the patient's teeth to create a true dimension working file of the patient's teeth having a shrunk volume with respect to enlarged volume using the scanner;
saving the true dimension working file;
creating a restoration file of the restoration based on the true dimension working file using the computer system;
saving the restoration file;
creating a cutting guide file of the cutting guide based on the true dimension working file and the restoration file using the computer system; and
saving the cutting guide file.

12. The method in accordance with claim 11, wherein the restoration is fabricated from the restoration file at a 1:1 ratio using the restoration fabricator; and wherein the cutting guide is fabricated from the fabrication file at a 1:1 ratio using the cutting guide fabricator.

13. The method in accordance with claim 11, wherein the compensation rate is approximately −0.2%.

14. The method in accordance with claim 3, wherein the positive dental stone model of the patient's teeth is scanned creating an enlarged scan of the patient's teeth with an enlarged volume; and further comprising:
saving a file of the enlarged scan;
retrieving the file of the enlarged scan using the computer system;
applying the compensation rate to the enlarged volume of the enlarged scan of the patient's teeth to create true dimension working file of the patient's teeth having a shrunk volume with respect to the enlarged volume using the computer system;
creating a restoration file of the restoration based on the true dimension working file using the computer system;
saving the restoration file;
creating a cutting guide file of the cutting guide based on the true dimension working file and the restoration file using the computer system; and
saving the cutting guide file.

15. The method in accordance with claim 3, wherein the positive dental stone model of the patient's teeth is scanned creating an enlarged scan of the patient's teeth with an enlarged volume; and further comprising:
saving a file of the enlarged scan;
retrieving the file of the enlarged scan with the computer system defining a enlarged dimension working file;
creating an enlarged restoration file of the restoration based on the enlarged dimension working file using the computer system;
saving the enlarged restoration file;
creating an enlarged cutting guide file of the cutting guide based on the enlarged dimension working file and the enlarged restoration file using the computer system;
saving the enlarged cutting guide file;
producing a true dimension restoration using the restoration fabricator by applying the compensation rate to a volume of the enlarged restoration file; and
producing a true dimension cutting guide using the cutting guide fabricator by applying the compensation rate to a volume of the enlarged cutting guide file.

16. The method in accordance with claim 3, wherein the positive dental stone model of the patient's teeth is scanned creating a shrunk scan of the patient's teeth with a shrunk volume; and further comprising:
applying the compensation rate to the shrunk volume of the scan of the patient's teeth to create a true dimension working file of the patient's teeth having an enlarged volume with respect to the shrunk volume using the scanner;
saving the true dimension working file;
retrieving the true dimension working file with the computer system;
creating a restoration file of the restoration based on the true dimension working file using the computer system;
saving the restoration file;
creating a cutting guide file of the cutting guide based on the true dimension working file and the restoration file using the computer system; and
saving the cutting guide file.

17. The method in accordance with claim 3, wherein the positive dental stone model of the patient's teeth is scanned creating a shrunk scan of the patient's teeth with a shrunk volume; and further comprising:
saving a file of the shrunk scan;
retrieving the file of the shrunk scan using the computer system;
applying the compensation rate to the shrunk volume of the shrunk scan of the patient's teeth to create true dimension working file of the patient's teeth having an enlarged volume with respect to the shrunk volume using the computer system;
creating a restoration file of the restoration based on the true dimension working file using the computer system;
saving the restoration file;
creating a cutting guide file of the cutting guide based on the true dimension working file and the restoration file using the computer system; and
saving the cutting guide file.

18. The method in accordance with claim 3, wherein the positive dental stone model of the patient's teeth is scanned creating a shrunk scan of the patient's teeth with a shrunk volume; and further comprising:
saving a file of the shrunk scan;
retrieving the file of the shrunk scan with the computer system defining a shrunk dimension working file;
creating a shrunk restoration file of the restoration based on the shrunk dimension working file using the computer system;
saving the shrunk restoration file;
creating a shrunk cutting guide file of the cutting guide based on the shrunk dimension working file and the shrunk restoration file using the computer system;
saving the shrunk cutting guide file;
producing a true dimension restoration using the restoration fabricator by applying the compensation rate to a volume of the shrunk restoration file; and
producing a true dimension cutting guide using the cutting guide fabricator by applying the compensation rate to a volume of the shrunk cutting guide file.

19. A method for creating a substantially accurate dental restoration, the method comprising:
a) obtaining a negative dental impression of a patient's teeth formed of a material with a known shrinkage rate and being shrunken with respect to the patient's teeth;
b) forming a positive dental stone model of the patient's teeth by applying a dental stone material to the negative dental impression, the dental stone material having a known expansion rate and being enlarged and having an enlarged volume with respect to the patient's teeth;
c) determining a compensation rate based on the known shrinkage rate of the material of the negative dental impression and the known expansion rate of the material of the positive dental stone model;
d) scanning the dental stone model of the patient's teeth using a three dimensional scanner to create an enlarged scan of the patient's teeth;
e) applying the compensation rate to the enlarged volume of the scan of the patient's teeth to create a true dimension working file of the patient's teeth having a shrunk volume with respect to enlarged volume using the scanner;
f) saving the true dimension working file;
g) designing a restoration and creating a restoration file of the restoration based on the true dimension working file using the computer system;
h) saving the restoration file;
i) designing a cutting guide and creating a cutting guide file of the cutting guide based on the true dimension working file and the restoration file using the computer system, the cutting guide being configured to guide a cutting tool to cut a patient's tooth prior to receiving the restoration;
j) saving the cutting guide file;
k) retrieving the restoration file with a restoration fabricator;
l) fabricating the restoration using the restoration fabricator;
m) retrieving the cutting guide file with a cutting guide fabricator; and
n) fabricating the cutting guide using the cutting guide fabricator.

20. The method in accordance with claim 19, further comprising completing any of the method under the control of one or more computer systems configured with executable instructions.

21. A method for creating a substantially accurate dental restoration and cutting guide, the method comprising:
a) scanning a negative dental impression of a patient's teeth or a positive dental stone model of the patient's teeth using a three dimensional scanner to create a scan of the patient's teeth, the negative dental impression being shrunk with respect to the patient's teeth, or the positive dental stone model being shrunk or enlarged with respect to the patients teeth;
b) applying a compensation rate, to compensate for the shrunk or enlarged scan of the patients teeth, to:
i) the scan of the patient's teeth using the scanner to create a true dimension working file, and saving the true dimension working file prior to designing and fabricating the restoration and the cutting guide; or
ii) the scan of the patient's teeth using a computer system to create a true dimension working file prior to designing and fabricating the restoration and the cutting guide; or
iii) a shrunk or enlarged restoration file of the restoration using a restoration fabricator prior to fabricating the restoration, and a shrunk or enlarged cutting guide file of the cutting guide using a cutting guide fabricator prior to fabricating the cutting guide;
c) wherein the compensation rate satisfies an equation:
A³=α³B³,
where A is the actual tooth size between two points,
B is after-shrinkage linear distance of the same points in the impression or the model, and
α is the compensation rate;
d) designing a restoration based on the scan of the patient's teeth and creating a restoration file;
e) fabricating the restoration using a restoration fabricator;
f) designing a cutting guide based on the scan of the patient's teeth and the restoration, and creating a cutting guide file, the cutting guide being configured to guide a cutting tool to cut a patient's tooth prior to receiving the restoration; and
g) fabricating the cutting guide with a cutting guide fabricator.
